(19) United States
(12) Patent Application Publication
(10) Pub. No.: US 2021/0053206 A1
(43) Pub. Date: Feb. 25, 2021

(54) FRAME

(71) Applicant: TRIPLE WIN TECHNOLOGY(SHENZHEN) CO.LTD., Shenzhen (CN)

(72) Inventor: DAN-DAN ZHANG, Shenzhen (CN)

(21) Appl. No.: 16/580,137

(22) Filed: Sep. 24, 2019

(30) Foreign Application Priority Data
Aug. 20, 2019 (CN) 201910770518.6

(51) Int. Cl. B25H 3/00; B25H 3/04

(52) U.S. Cl. CPC B25H 3/006; B25H 3/04

(57) ABSTRACT

A frame includes a bracket and a number of fixing brackets. The bracket forms a multi-layer stacking space. The fixing brackets are mounted on the bracket. The fixing frame includes a number of hook portions configured to hook onto the bracket to mount the fixing frame on the bracket. The fixing bracket defines a number of through holes in a mesh structure. Each through hole is configured to receive a glue-filled hose.

### FIELD

The subject matter herein generally relates to frames, and more particularly to a frame for placing a plurality of glue-filled hoses in a cooling device.

### BACKGROUND

Many electronic devices require low-temperature glue when assembling. A glue-filled hose is placed in a cooling device for cooling the glue. However, a rubber frame in the related art cannot completely utilize a space in a cooling device to cool the glue. Thus, a utilization rate of the cooling device is not optimized.

### BRIEF DESCRIPTION OF THE DRAWINGS

Implementations of the present disclosure will now be described, by way of embodiments, with reference to the attached figures.

FIG. 1 is an assembled, isometric view of an embodiment of a frame.

FIG. 2 is an exploded, isometric view of the frame in FIG. 1.

FIG. 3 is an isometric view of a bracket of the frame.

FIG. 4 is a diagram of a fixing bracket of the frame.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

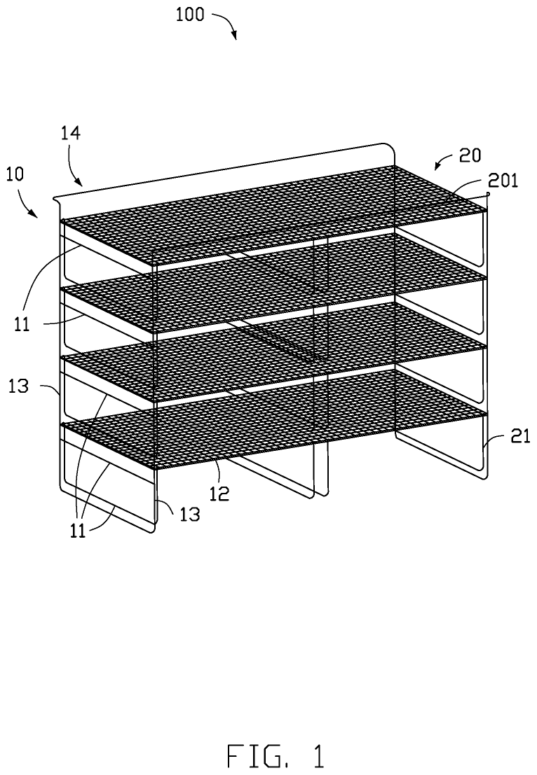

FIG. 1 shows an embodiment of a frame 100 applied in a cooling device (not shown). In one embodiment, the frame 100 is made of plastic and is configured to hold a plurality of glue-filled tubes (not shown) for cooling the glue inside the tubes.

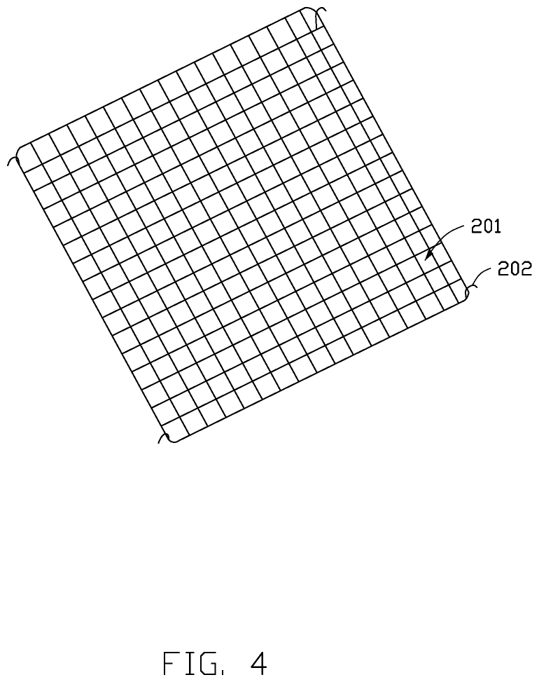

The frame 100 includes a bracket 10 and at least one detachable fixing bracket 20. The bracket 10 provides a multi-layer stacking space. As shown in FIG. 4, an edge of the fixing frame 20 includes a hook portion 202 for mounting the fixing bracket 20 on the bracket 10. The fixing frame 20 defines at least one through hole 201 for receiving a corresponding tube.

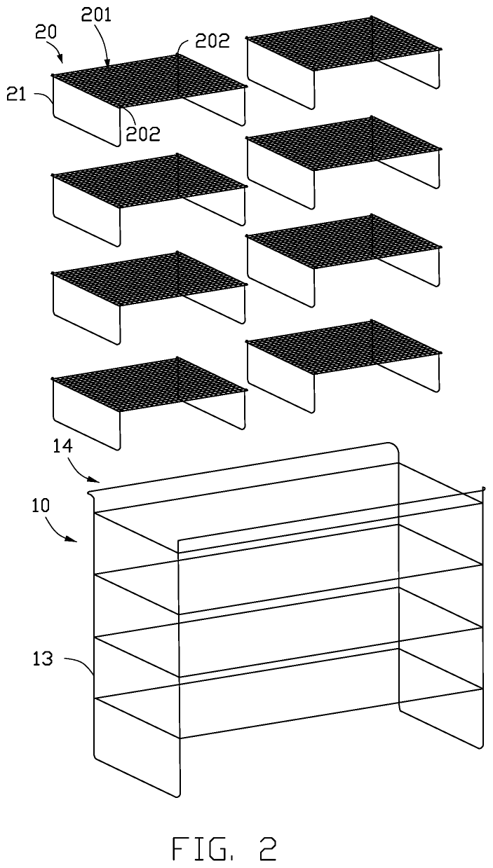

The bracket 10 is designed according to an internal space of the cooling device such that an overall size of the bracket 10 is substantially the same as an internal space of the cooling device. Referring to FIG. 2, the bracket 10 includes a plurality of first fixing rods 11, a plurality of second fixing rods 12, and a plurality of connecting rods 13. The bracket 10 is a frame formed by connecting the first fixing rods 11, the second fixing rods 12, and the connecting rods 13 together.

Two ends of the first fixing rods 11 and two ends of the second fixing rods 12 are respectively fixed to corresponding connecting rods 13. The first fixing rod 11 and the second fixing rod 12 are substantially perpendicular to each other. Specifically, the first fixing rods 11 extend along an X-axis direction, the second fixing rods 12 extend along a Y-axis direction, and the connecting rods 13 extend along a Z-axis direction in a coordinate system. The first fixing rods 11, the second fixing rods 12, and the connecting rods 13 form a substantially rectangular parallelepiped structure. The connecting rods 13 are respectively located at four corner sides of the bracket 10. The first fixing rods 11 are located at two opposite sides of the bracket 10, and the second fixing rods 12 are located at another two opposite sides of the bracket 10. The first fixing rods 11 and the second fixing rods 12 are arranged along the Z-axis direction. A height of each second fixing rod 12 from a bottom-most pair of first fixing rods 11 is higher than the corresponding adjacent first fixing rod 11.

In one embodiment, the bracket 10 includes five pairs of first fixing rods 11 and four pairs of second fixing rods 12 arranged along the Z-axis direction, so that the bracket 10 includes four layers of space along the Z-axis direction for mounting the fixing brackets 20. The pair of bottom-most first fixing rods 11 is used to support the bracket 10 within the cooling device. In other embodiments, a quantity of the first fixing rods 11 and the second fixing rods 12 can be changed according to a size of the cooling device. The first fixing rods 11, the second fixing rods 12, and the connecting rod 13 may be welded together to form the bracket 10, or the bracket 10 can be integrally formed.

As shown in FIG. 2, the bracket 10 includes a pair of abutting portions 14 at a top of the bracket 10. Each abutting portion 14 extends from a corresponding top-most second fixing rod 12 and is coupled to two corresponding connecting rods 13. Each abutting portion 14 curves away from the other abutting portion 14 and is configured to abut against an edge of the cooling device to more conveniently fix the bracket 10 to the cooling device or more conveniently take out the bracket 10 from the cooling device. In other embodiments, each abutting portion 14 extends from a corresponding top-most first fixing rod 11 and is coupled to two corresponding connecting rods 13 and curves away from the other abutting portion 14. In other embodiments, there are four abutting portions 14 respectively extending from the top-most first fixing rods 11 and the top-most second fixing rods 12.

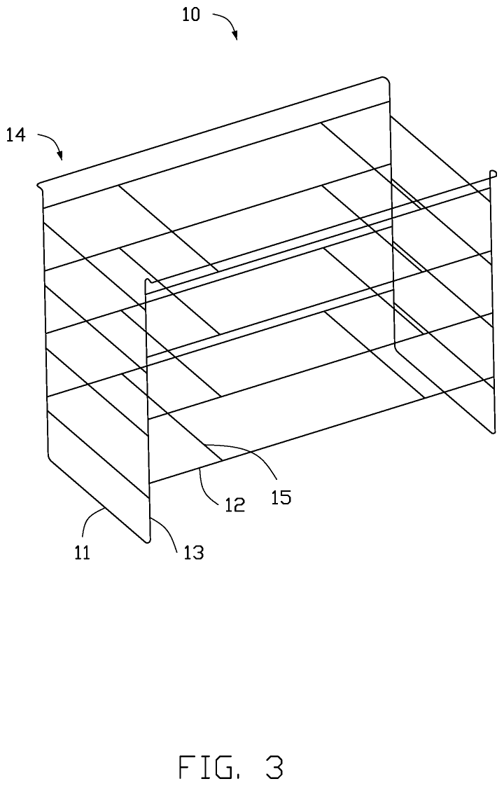

As shown in FIG. 3, in another embodiment, in order to better support the fixing frame 20, the bracket 10 further includes at least one first support portion 15 arranged along the same direction as the first fixing rods 11. Specifically, the first support portion 15 is substantially parallel to the first fixing rods 11, and two ends of the first support portion 15 are respectively coupled to a pair of second fixing rods 12. The first support portion 15 supports the fixing bracket 20 when the fixing bracket 20 is mounted on the bracket 10.

Referring again to FIG. 2, the fixing frame 20 defines a plurality of the through holes 201. The plurality of through holes 201 form a mesh structure. A size of the fixing frame 20 is determined according to lengths of the first fixing rod 11 and the second fixing rod 12 of the bracket 10. A shape and size of the through holes 201 can be designed according to a size of the hose. In one embodiment, an opening of the through hole 201 is substantially rectangular. It should be understood that if the hose is cylindrical, the opening of the through hole 201 is a circle to fit the hose. The hook portion 202 is located at an edge of the fixing frame 20 such that when the fixing bracket 20 is mounted on the bracket 10, the hook portion 202 hooks on the second fixing rod 12, and there is sufficient space to place the hose.

In one embodiment, each level of the bracket 10 can mount two fixing brackets 20, such that a sum of lengths of the two fixing brackets 20 is substantially equal to a length of the second fixing rod 12, and a width of each fixing bracket 20 is substantially equal to a length of the first fixing rod 11. In other embodiments, each level of the bracket 10 mounts two fixing brackets 20, such that a sum of widths of the two fixing brackets 20 is substantially equal to the length of the first fixing rod 11, and a length of each fixing bracket 20 is substantially equal to the length of the second fixing rod 12. In other embodiments, more than two fixing brackets 20 can be mounted on each level of the bracket 10, such that a total length and a total width of the fixing brackets 20 are substantially equal to the length of the second fixing rod 12 and the length of the first fixing rod 11, respectively.

In one embodiment, each fixing frame 20 includes two second support portions 21. The two second support portions 21 are respectively located at opposite ends of the fixing frame 20 and are substantially perpendicular to the fixing frame 20. Each second support portion 21 is substantially a U-shaped structure, and two ends of the second support portion 21 are coupled to an edge of the fixing frame 20. When the fixing frame 20 is mounted on the bracket 10, at least one second support portion 21 is adjacent to the first fixing rod 11. When the fixing frame 20 is removed from the bracket 10, the second support portions 21 support the fixing frame 20 upright to prevent the hose from contacting the ground.

In one embodiment, each end of the second support portion 21 is coupled to a corresponding hook portion 202. The hook portions 202 and the second support portion 21 may be integrally formed. Specifically, the second support portion 21 is fastened to the edge of the fixing frame 20 by passing the hook portions 202 through corresponding through holes 201 to hook the hook portions 202 to the fixing frame 20. Specifically, the hook portion 202 passes through the through hole 201 at the corner of the fixing frame 20 to fasten the fixing frame 20. When the fixing frame 20 is mounted on the bracket 10, the hook portions 202 can further hook onto the second fixing rods 12. If the second support portions 21 are not needed, the two ends of the second support portion 21 can be pressed inward to elastically deform to unhook the hook portions 202 from the fixing bracket 20 and remove the second support portion 21.

In other embodiments, the second support portions 21 may be omitted, such that the fixing bracket 20 is mounted on the bracket 10 by the hook portions 202.

Referring again to FIG. 1, in assembly, the fixing brackets 20 are mounted on the bracket 10 by the hook portions 202 hooking onto the second fixing rods 12, thereby forming the frame 100. After the frame 100 is placed in the cooling device, the glue-filled tubes can be placed through the through holes 201 to cool the glue. In one embodiment, the bracket 10 includes eight fixing brackets 20. It should be understood that in other embodiments, the frame 100 can include a different quantity of the fixing brackets 20.

In summary, the frame 100 includes the bracket 10 designed according to an internal space of the cooling device, and the fixing frames 20 designed according to the size of the bracket 10. Further, a quantity of the through holes 201 is increased, thereby increasing a quantity of glue-filled rubber tubes that can simultaneously be cooled in the frame 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A frame configured to be placed inside a cooling device, the frame holding a glue-filled hose, the frame comprising:
a bracket forming a multi-layer stacking space; and
a plurality of fixing brackets detachably mounted on the bracket; wherein:
an edge of the fixing bracket comprises a hook portion configured to hook onto the bracket to mount the fixing bracket on the bracket;
each of the fixing brackets defines at least one through hole configured for receiving the glue-filled hose.

2. The frame of claim 1, wherein:
each of the fixing brackets defines a plurality of through holes in a mesh structure.

3. The frame of claim 1, wherein:
the bracket comprises a first fixing rod, a second fixing rod, and a connecting rod;
each of two ends of the first fixing rod and each of two ends of the second fixing rod are fixedly coupled to the connecting rod; and
the first fixing rod is perpendicular to the second fixing rod.

4. The frame of claim 3 further comprising a first support portion, wherein:
a first support portion is coupled to the second fixing rod and is parallel to the first fixing rod.

5. The frame of claim 4, wherein:
when the fixing bracket is mounted on the bracket, the hook portion hooks onto the second fixing rod.

6. The frame of claim 5, wherein:
the first fixing rod and the second fixing rod are not located in a same plane.

7. The frame of claim 6, further comprising two abutting portions, wherein:
two ends of each of the abutting portions are coupled to the connecting rod.

8. The frame of claim 2, wherein:
the fixing bracket comprises two second support portions respectively located at opposite ends of the fixing frame and substantially perpendicular to the fixing frame;
each of the second support portions is U-shaped;
each of two ends of each second support portion is coupled to a corresponding hook portion; and
the second support portion is hooked onto the fixing bracket by the hook portions.

9. A frame comprising:
a bracket forming a multi-layer stacking space; and
a plurality of fixing brackets configured to be mounted on the bracket; wherein:
the fixing frame comprises a plurality of hook portions configured to hook onto the bracket to mount the fixing frame on the bracket;
the fixing bracket defines a plurality of through holes in a mesh structure, each through hole configured to receive a glue-filled hose.

10. The frame of claim 9, wherein:
the bracket comprises a plurality of pairs of first fixing rods, a plurality of pairs of second fixing rods, and a plurality of connecting rods; wherein:
the plurality of pairs of first fixing rods extends along an X-axis direction;
the plurality of pairs of second fixing rods extends along a Y-axis direction; and
the plurality of pairs of connecting rods extends along a Z-axis direction; and
each of two ends of each first fixing rod and each of two ends of each second fixing rod are fixedly coupled to corresponding connecting rods.

11. The frame of claim 10, wherein:
the plurality of pairs of first fixing rods, the plurality of pairs of second fixing rods, and the plurality of connecting rods are arranged along the Z-axis direction to form the multi-level stacking space;
a total length of the fixing brackets mounted on a same level is equal to a length of the second fixing rod; and
a total length of the fixing brackets mounted on the same level is equal to a length of the first fixing rod.

12. The frame of claim 11, wherein:
the hook portions hook onto corresponding second fixing rods.
